(19) United States
(12) Patent Application Publication
(10) Pub. No.: US 2025/0358557 A1
(43) Pub. Date: Nov. 20, 2025

(54) ELECTRONIC DEVICE SPEAKER ASSEMBLY

(71) Applicant: Apple Inc., Cupertino, CA (US)

(72) Inventors: Alison B. Shutzberg, San Francisco, CA (US); Ibuki Kamei, Santa Clara, CA (US); Daniel W. Corona, San Francisco, CA (US); Scott P. Porter, San Jose, CA (US)

(21) Appl. No.: 19/188,417

(22) Filed: Apr. 24, 2025

Related U.S. Application Data
(60) Provisional application No. 63/648,588, filed on May 16, 2024.

(51) Int. Cl. H04R 1/02; G02B 27/01; H04R 1/08

(52) U.S. Cl. CPC H04R 1/025; G02B 27/0176; H04R 1/028; H04R 1/08; G02B 2027/0178; H04R 2499/11; H04R 2499/15

(57) ABSTRACT

A wearable electronic display device can include a display frame coupled to a display window, a securement arm extending distally from the display frame, the securement arm including an arm housing forming a single, unitary piece, and the arm housing defining a first aperture and a second aperture. A first electronic component can be disposed within the arm housing, a second electronic component can be disposed within the arm housing, and a speaker assembly can be disposed between the first electronic component and the second electronic component.

### RELATED APPLICATION(S)

The present application depends from and claims priority to U.S. Provisional Patent Application No. 63/648,588 filed 16 May 2024, titled “Electronic Device Speaker Assembly,” the entire contents of which is incorporated by reference in its entirety.

### FIELD

The described embodiments relate generally to wearable electronic devices. More particularly, the present embodiments relate to speaker integration for wearable electronic devices.

### BACKGROUND

Recent advances in portable computing have led to the integration of speakers into wearable electronic devices. M any wearable electronic devices include large internal volumes to accommodate various electronic components, including speakers. However, large internal volumes accommodating various components can result in heavy and uncomfortable devices. Furthermore, small internal volumes increase the difficulty of assembly and sealing of speakers therein and can impact audio quality. Therefore, what is needed in the art is a wearable electronic device that can fit speakers and speaker assemblies into small internal volumes while maintaining manufacturability, comfort, and sound quality.

### SUMMARY

In at least one example of the present disclosure, a wearable electronic device can include a display frame, a securement arm, and a speaker assembly. The securement arm can extend distally from the display frame. The securement arm can include a housing defining a first aperture and a second aperture. The speaker assembly can be disposed within the housing. The speaker assembly can include a first audio port and a second audio port. The first audio port can be aligned proximal relative to the first aperture, and it can be in fluid communication with a first terminal end of the speaker assembly. The second audio port can be aligned proximal relative to the second aperture and in fluid communication with a second terminal end of the speaker assembly. The wearable electronic device can also include a first seal, a second seal, and a third seal. The first seal can be disposed within the housing proximal to the speaker assembly and the first audio port. The second seal can be disposed within the housing distal to the speaker assembly and the second audio port. The third seal can be disposed within the housing between the speaker assembly and the second seal.

In some examples, the first seal can be fluid tight. In some examples, the wearable electronic display device can further include at least one of an acoustic seal or a micro perforation disposed about at least one of the first aperture or the second aperture between the speaker assembly and the securement arm. In some examples, the wearable electronic display device can further include a first electronic component disposed within the housing and positioned proximal relative to the first seal or distal relative to the second seal. In some examples, the first electronic component can include a microphone. In some examples, the second audio port can be configured to allow fluid egress from the microphone and from at least one of the first terminal end of the speaker assembly or the second terminal end of the speaker assembly. In some examples, the wearable electronic display device can further include a second electronic component disposed within the housing and proximal relative to the first seal or distal relative to the second seal. In some examples, at least one of the first electronic component or the second electronic component can include at least one or more of a microphone, a battery, a projector, a processor, a camera, or a sensor. In some examples the wearable electronic device can further include an acoustic opening defined by in the housing between the second seal and the third seal.

In at least one example a wearable audio device can include a securement arm and a housing. The securement arm can include a housing. The housing can have a tapered portion defining an interior cavity. The tapered portion can define a first aperture and a second aperture. The housing can define a first port proximal to the first aperture and a second port proximal to the second aperture. The tapered portion can include a speaker assembly, a first seal, a second seal, and a third seal. The speaker assembly can be positioned between the first port and the second port. The first seal can be positioned proximally from the first port. The second seal can be positioned distally from the second port. The third seal can be positioned between the speaker assembly and the second port.

In some examples, the wearable audio device can further include an acoustic mesh disposed in the tapered portion. In some examples, the wearable audio device can further include an electronic component disposed in the securement arm and a fluid-tight seal disposed between the housing and the electronic component. In some examples, the tapered portion can extend from the fluid-tight seal toward the housing into a notch. In some examples, the first port can include a hinge port. In some examples, the wearable audio device can further include an acoustic opening disposed in the housing between the second seal and the third seal and can be aligned proximal to the second port. In some examples, the first seal can include a direct seal. In some examples, the second seal can include a first indirect seal. In some examples, the third seal can include a second indirect seal. In some examples, a tightening of a fastener can be configured to rotate the speaker assembly about a fulcrum to draw the speaker assembly against the housing at the first aperture and draw the speaker assembly against the elongate housing at the second aperture.

In at least one example of the present disclosure, a securement arm for a wearable electronic device can include an elongated housing, a speaker assembly, a face seal, a first radial seal, and a second radial seal. The elongated housing can define a first aperture and a second aperture. A speaker assembly can include a first audio port aligned with the first aperture and a second audio port aligned with the second aperture. The face seal can be disposed within the housing and aligned with a first end of the speaker assembly. The first radial seal can be disposed within the housing and aligned with a second end of the speaker assembly. The second audio port can be disposed between the second radial seal and the first radial seal.

In some examples, the face seal can include a fluid tight seal. In some examples, the second radial seal can be configured to prevent fluid communication between the first audio port and the second audio port. In some examples, the securement arm for a wearable electronic device can further include an electronic component disposed within the housing distal relative to the second radial seal.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 shows a perspective view of an example of a wearable electronic device;

FIG. 2 shows a cross-section of an example of a securement arm;

FIG. 3 shows a perspective view of an example of a securement arm;

FIG. 4A shows a cross-section of a portion of an example of a securement arm;

FIG. 4B shows a cross-section of a portion of an example of a securement arm speaker assembly, and securement apparatus during installation;

FIG. 4C shows another cross-section of a portion of an example of a securement arm speaker assembly, and securement apparatus after installation;

FIG. 5A shows a cross-section of a portion of an example securement arm and speaker assembly during installation;

FIG. 5B shows a cross-section of a portion of an example securement arm and speaker assembly after installation;

FIG. 6A shows a cross-section of a portion of an example securement arm and speaker assembly during installation;

FIG. 6B shows a cross-section of a portion of an example securement arm and speaker assembly after installation;

FIG. 6C shows a cross-section of a portion of an example securement arm, speaker assembly, and a mesh cover;

FIG. 7A shows another cross-section of a portion of an example wearable electronic device and speaker assembly;

FIG. 7B shows cross-section of a portion of an example wearable electronic device and speaker assembly;

FIG. 8A shows a cross-section of a portion of an example of a securement arm and speaker assembly;

FIG. 8B shows a cross-section of a portion of an example of a securement arm and speaker assembly;

FIG. 8C shows a cross-section of a portion of an example of a securement arm and speaker assembly;

FIG. 9 shows a cross-section of a portion of an example of a securement arm and speaker assembly;

FIG. 10 shows a cross-section of a portion of an example of a securement arm and speaker assembly.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

The following disclosure relates to a wearable electronic display device. More particularly, the following disclosure relates to the integration and securement of a speaker or speaker assembly into a wearable electronic display device. Wearable electronic devices can provide a user with visual media and audio, often in the form of videos, movies, notifications, calls, web surfing, or other sources. In some cases, the wearable electronic display device can emit audio including sensitive information, identifiable information, or other sounds that a user may desire to keep private. In other examples, a user may utilize the wearable electronic display device in a quiet environment or wish not to disturb those around the user with audio output. In some examples detailed in the present application, a wearable electronic display device can include a speaker assembly with noise-cancelling functionality. In some examples, the speaker assembly can emit one audio output directed toward the ear of a user, and emit another, different, audio output directed away from the user. The two different audio outputs can destructively interfere or otherwise interact such as to reduce or minimize the audio detectable by those around the user.

In some examples, one or more speaker assemblies including one or more speakers can be disposed within one or more securement arms of a wearable electronic display device. The wearable electronic device can include a display frame, and the securement arms can extend distally from the display frame and be configured to rest against the user's ears or head when the wearable electronic display device is donned. In this way, the wearable electronic device can operate similar to or include examples such as head mountable devices, including virtual reality devices, augmented reality devices, etc., and eyewear similar to eyeglasses or sunglasses. The securement arms can include a housing defining a first aperture and a second aperture, or in other words the securement arms can include two holes within the housing. The speaker assembly can further include one or more audio ports, and the audio ports can be aligned with the apertures. These one or more audio ports can allow fluid communication, such as airflow or the flow of sounds through vibrations from the one or more speaker assemblies between an external environment, such as the area near a user's ear when the device has been donned by a user, and a portion within the housing, such as an end of the speaker assembly. One or more seals can be disposed within the housing to control the fluid communication between the external environment through the ports with the speaker assembly and other components disposed within the securement arms. Specifically, the seals can limit or eliminate the flow of fluids, such as air, to allow fluid flow in some portions of the interior of the wearable electronic device while limiting or blocking the fluid from flowing to other portions of the interior of the wearable electronic device. In some examples, one seal can be disposed within the housing proximal to the speaker assembly and the first audio port, a second seal can be disposed within the housing distal to the speaker assembly and the second audio port and a third seal can be disposed within the housing between the speaker assembly and the second seal. In other words, in some examples, the holes within the housing can be covered with one or more seals, and one or more seals can be included within the internal cavity of the securement arm's housing to create separate portions of the internal cavity to limit or reduce the allowed fluid communication between the portions.

In some examples, a wearable audio device can include a securement arm including a housing. The housing can include a tapered portion defining an interior cavity. The tapered portion of the housing can resemble a wedge or have any geometry that can mimic the geometry of the wearable audio device which may be tapered for comfort and securement of the wearable audio device over an ear of a user when the wearable audio device is donned. The tapered portion can define apertures, or holes or cavities, such as a first aperture and a second aperture. One or more ports can be defined by the housing and aligned with the apertures. For example, a first port can be defined by the housing and can be positioned aligned with the first aperture. A second port can similarly be defined by the housing and can be positioned aligned with the second aperture. In some examples, the wearable audio device can include one or more electronic components such as one or more speaker assemblies. These electronic components can be positioned throughout the securement arm, including within the tapered portion of the housing between the first port and the second port. The tapered portion of the housing can also include one or more seals. The seals can be positioned in various places throughout the securement arms to limit or cut off fluid flow throughout the securement arm, for example a first seal can be positioned proximally from the first port, a second seal can be positioned distally from the second port, and a third seal can be positioned between the speaker assembly and the second port. In this configuration, the third seal can reduce or eliminate fluid flow between the first port and the second port.

In some examples, a securement arm for a wearable electronic device can include an elongated housing defining a first aperture and a second aperture. The securement arm can also include a speaker assembly and one or more seals. The speaker assembly can include a first audio port and a second audio port, the audio ports can allow air and vibrations from sounds to flow through the securement arm between the speaker assembly and the exterior environment to allow a user of the wearable electronic device to listen to audio such as music, podcasts, a phone call, or audio connected to a visual entertainment, to list a few specific examples. The first audio port and the second audio port can be aligned with the first aperture and the second aperture, respectively. Additional audio ports can be included with additional apertures. In some examples, a first seal, such as a face seal, can be disposed within the housing and aligned with a first end of the speaker assembly to control fluid communication with the first port and a first end of the speaker assembly. In some examples, a second seal, which in some examples is a radial seal, can be disposed within the housing and aligned with a second end of the speaker assembly to control fluid communication with the second port and a second end of the speaker assembly. A third seal, such as a second radial seal, can be disposed between the second radial seal and the first radial seal, reducing, or blocking fluid communication between the first audio port and the second audio port. In this specific configuration, the wearable audio device can ensure that the fluid flowing through the first audio port, such as sound intended to be heard by s user, is separate from the fluid flowing through the second audio port through the third seal. This can prevent the sounds intended to be heard by the user for example through the first audio port from being heard by others through the second audio port. This can increase the privacy of the user when they are using the wearable electronic device and/or it can allow for sound cancelling by allowing air flow between the front end and the back end of the speaker assembly and the external environment while preventing fluid flow between the first audio port and the second audio port through the third seal.

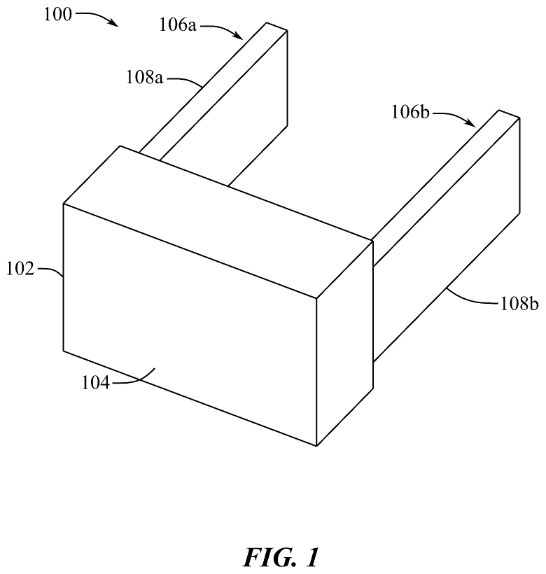

These and other embodiments are discussed below with reference to FIGS. 1-10. However, those skilled in the art will readily appreciate that the detailed description given herein with respect to these figures is for explanatory purposes only and should not be construed as limiting. Furthermore, as used herein, a system, a method, an article, a component, a feature, or a sub-feature including at least one of a first option, a second option, or a third option should be understood as referring to a system, a method, an article, a component, a feature, or a sub-feature that can include one of each listed option (e.g., only one of the first option, only one of the second option, or only one of the third option), multiple of a single listed option (e.g., two or more of the first option), two options simultaneously (e.g., one of the first option and one of the second option), or combination thereof (e.g., two of the first option and one of the second option).

FIG. 1 shows an example of a wearable electronic display device 100. The wearable electronic display device 100 can be a head-mounted device, resting on the face of a user and being supported by the head, nose, ears, and/or other body part of a user. In some examples, the wearable electronic display device 100 can provide a user with a visual or auditory experience. In some examples, the wearable electronic display device 100 can be an augmented reality device or a virtual reality device. The wearable electronic display device 100 can include a display frame 102 coupled to a display window 104. In some examples, the display window 104 can be at least partially transparent, allowing a user to see through the display window 104. The display window 104 can overlay information, graphics, video, or other media over the field of view of a user. In other examples, the display window 104 can be a screen that at least partially fills the field of view of a user. The screen can be a LED screen, an OLED screen, a projection, an LCD screen, or another type of screen.

The wearable electronic display device 100 can also include securement arms 106a-b extending distally from the display frame 102. The securement arms 106a-b can rest on the ears of a user and/or engage a side of a user's head and can at least partially support the wearable electronic display device 100. Each of the securement arms 106a-b can include an arm housing 108a-b forming a single, unitary piece. In some examples, the securement arms 106a-b can be manufactured from polymers, composites, or metals. Each of the securement arms 106a-b can be injection molded, cast, machined, or welded to produce a unitary piece. In some examples, the securement arms 106a-b can be foldably attached to the display frame 102. Foldable securement arms 106a-b can collapse inward toward the display frame 102, increasing portability and decreasing the stowed size of the wearable electronic display device. In other examples, the securement arms 106a-b can be removably secured to the display frame 102. Removable securement arms 106a-b can allow the securement arms 106a-b to detach during a drop event, preventing damage to the wearable electronic display device 100. In yet other examples, the securement arms 106a-b can be fixedly attached to the display frame 102. Fixedly attached securement arms 106a-b can protect electrical connectors or other electrical components disposed within the securement arms 106a-b or extending through the connection between the securement arms 106a-b and the display frame 102. In some examples, the securement arms 106a-b can be any geometry including one or more straight or curved edges. In some examples, the securement arms 106a-b housings 108a-b can also be of any geometry including rectangular, cylindrical, or of a tapered geometry. In some examples, the securement arm 106a can mirror the geometry of securement arm 106b. In other examples, the securement arm 106a can differ from the geometry of securement arm 106b.

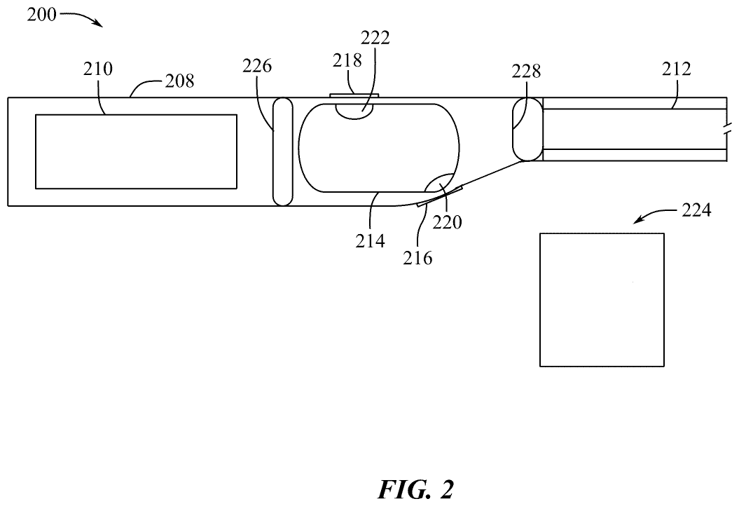

Any of the features, components, and/or parts, including the arrangements and configurations thereof shown in FIG. 1 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 1. Examples of securement arms including electronic components and speaker are given below in reference to FIG. 2.

FIG. 2 shows a cross-section of an example securement arm 200. The securement arm 200 can include an arm housing 208. Various electronic components such as speakers, batteries, processors, projectors, electrical connectors, microphones, sensors, cameras, and/or other electronic components can be disposed within the arm housing 208. The electrical components disposed within in the arm housing 208 can function separately or together to produce visual, auditory, sensory, or other experiences for a user. In some examples, the securement arm 200 can include a first electronic component 210 disposed within the arm housing 208, and a second electronic component 212 disposed within the arm housing 208. In some examples, the first electronic component 210 can be a projector configured to direct light displayed at the display window 104 described in reference to FIG. 1, or any of the other electronic components described above. In some examples, the second electronic component 212 can be a battery, or any of the other electronic components listed above.

In some examples, the securement arm 200 can also include a speaker assembly 214 disposed between the first electronic component 210 and the second electronic component 212. In some examples, the speaker assembly 214 can include one or more speakers. In other examples, the speaker assembly 214 can include one diaphragm in fluid communication with multiple speaker volumes. The speaker assembly 214 can also be configured to simultaneously emit multiple audio outputs. In some examples, the speaker assembly 214 can be configured to direct audio output toward the ear 224 of a user and direct noise-cancelling audio output away from the ear 224 of a user. Directing noise-cancelling audio output away from the ear 224 of a user can improve privacy by limiting the amount of sound audible in the vicinity of the user. Increased privacy can protect the user's personal information, preferences, private conversations, and other sensitive audio output. The arm housing 208 can define a first aperture 216 and a second aperture 218, and the speaker assembly can include a first audio port 220 aligned with the first aperture 216 and a second audio port 222 aligned with the second aperture 218. In at least one example, the audio ports 220, 222, as well as other audio ports described herein, can include apertures or audio pathways included in or defined by the speaker assembly 214 allowing audio pressure waves generated by the diaphragm to exit the speaker assembly 214. In some examples, the first audio port 220 and first aperture 216 can allow sound waves to travel from the speaker assembly 214 toward the ear 224 of a user. In some examples, the second audio port 222 and the second aperture 218 can allow sound waves to travel from the speaker assembly 214 away from a portion of the user's body, including but not limited to the ear 224 of a user. In some examples, the speaker assembly 214 can be disposed between the first aperture 216 and the second aperture 218.

In some examples, the securement arm 200 can include one or more seals disposed within the arm housing 208. The seals can protect the electronic components disposed within the arm housing 208. For example, the seals can prevent dust, water, sweat, or other contaminants from entering the arm housing 208 and damaging the electronic components disposed therein. In some examples, the securement arm 200 can include a first seal 226 disposed within the arm housing 208 between the speaker assembly 214 and the first electronic component 210, and a second seal 228 disposed within the arm housing 208 between the speaker assembly 214 and the second electronic component 212. One or both of the seals 226, 228 can be fluid tight. The seals 226, 228 can fluidly isolate the speaker assembly 214 from other portions of the arm housing 208, thus improving audio quality and creating a predictable sound. The seals 226, 228 can also allow the arm housing 208 to include apertures 216, 218 for audio output to exit through without exposing the electronic components 210, 212 to external contaminants such as water, sweat, dust, or other contaminants. In some examples, the fluid-tight seals can be manufactured from rubber, polymers, composites, or other materials.

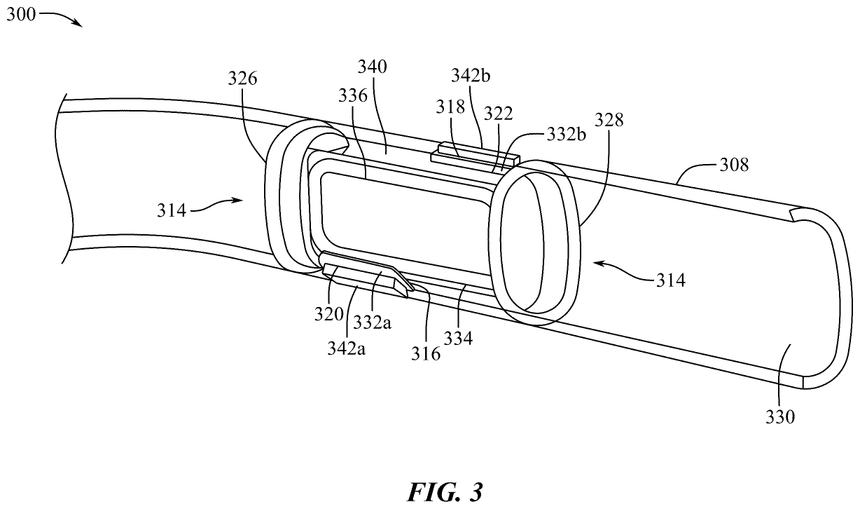

Any of the features, components, and/or parts, including the arrangements and configurations thereof shown in FIG. 2 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 2. Further examples of securement arms including speaker assemblies are described below in reference to FIG. 3.

FIG. 3 shows a perspective view of a cross-section of an example of a securement arm 300. The securement arm 300 can include an arm housing 308. In some examples, the arm housing 308 can be a wall defining a tubular shape. The securement arm 300 can define an inner surface 330. In some examples, the inner surface 330 can be a curved inner surface. The arm housing 308 can also define a first aperture 316 and a second aperture 318. In some examples, the first aperture 316 and the second aperture 318 can be configured to allow sound to exit the arm housing 308. The securement arm 300 can also include a speaker assembly 314 disposed within the arm housing 308 and configure to emit audio output. In some examples, the securement arm 300 can include an acoustic seal 332a disposed about the first aperture 316 between the speaker assembly 314 and the securement arm 300. The acoustic seal 332a can enhance the audio output quality by forming a tight seal between the speaker assembly 314 and the securement arm 300. By creating a tight seal between the speaker assembly 314 and the securement arm 300, the acoustic seal 332a can prevent vibration of the speaker assembly 314 against the arm housing 308. In some examples, the acoustic seal 332a can improve audio quality by directing audio output out the first aperture 316. Directing audio output out the first aperture 316 can prevent sound waves from resonating within the arm housing 308, reducing sound quality. In some examples, the acoustic seal 332a can be a fluid-tight seal. The acoustic seal 332a being a fluid-tight seal can prevent moisture from entering the securement arm 300, thus improving durability and longevity of the securement arm 300 by protecting the internal components from contaminants such as water, sweat, condensation, dust, dirt, and other contaminants.

In some examples, the speaker assembly 314 can be configured to emit audio output. The speaker assembly 314 can be configured to emit one audio output through the first aperture 316 and emit a different audio output through the second aperture 318. In some examples, the audio output emitted through the first aperture 316 can be directed toward the ear of a user, and can be audio from music, videos, notifications, or other functions performed by the wearable electronic display device 100 described in reference to FIG. 1. The audio emitted through the second aperture 318 can be noise-cancelling audio directed away from the ear of a user and can be configured to destructively interfere with the audio emitted through the first aperture 316, thus decreasing amount of volume of audio emitted through the first aperture 316 audible to people or audio detection devices in the vicinity of the user. By decreasing the amount of audio output detectable by people or devices in the vicinity of the user, the privacy of the user can be protected.

For example, the speaker assembly 314 can include a diaphragm housing 334 defining a first audio port 320 and a second audio port 322. A diaphragm 336 can be disposed within the diaphragm housing 334 and can define a front speaker volume 338 in fluid communication with the first audio port 320 and a rear volume 340 in fluid communication with the second audio port 322. In some examples, the diaphragm housing 334 can define a first port 320 aligned with the first aperture 316 and a second port 322 aligned with the second aperture 318. In some examples, the acoustic seal 332a can be a first seal disposed about the first aperture 316 and the first port 320 between the diaphragm housing 334 and the securement arm 300, and a second seal 332b can be disposed about the second aperture 318 and the second port 322 between the diaphragm housing 334 and the securement arm 300. In some examples, the first audio port 320 can be aligned with the first aperture 316 and the second audio port 322 can be aligned with the second aperture 318.

In some examples, the acoustic seal 332a can be a fluid-tight seal disposed about the first aperture 316 between the speaker assembly 314 and the securement arm 300, the fluid-tight seal fluidly isolating the front speaker volume 338 from an internal volume of the securement arm 300 defined between the arm housing 308 and the diaphragm housing 334. In some examples, the first aperture 316 and the second aperture 318 can each include a cosmetic mesh 342a-b. The cosmetic meshes 342a-b can improve the aesthetic qualities of the securement arm 300 and can further protect the internal components of the securement arm 300 from contamination, damage, or other external factors. Additionally, the speaker assembly 314 can include a first seal 326 and a second seal 328. The seals 326, 328 can abut the inner surface 330 and can provide frictional force to prevent the speaker assembly 314 from displacing. In some examples, the seal 326, 328 can also be fluid-tight seals.

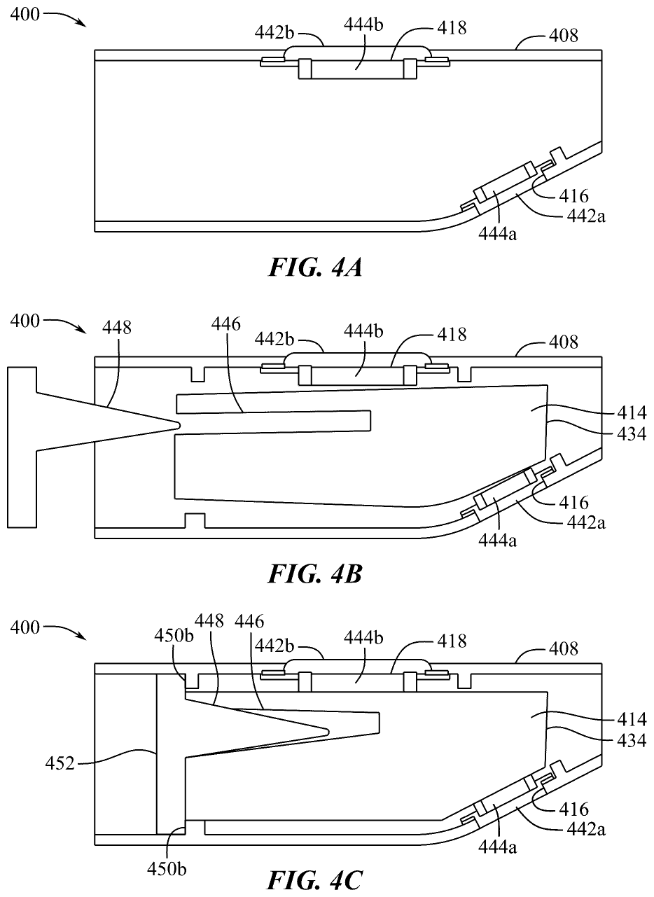

Any of the features, components, and/or parts, including the arrangements and configurations thereof shown in FIG. 3 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 3. Examples of speaker assemblies, wearable audio devices and assembly methods are given below in reference to FIGS. 4A-4C.

FIGS. 4A-4C show a cross-section of a portion of a wearable audio device 400 before, during, and after installation of a speaker assembly. In some examples, a portion of the wearable audio device 400 can be a securement arm. FIG. 4A shows a cross-section of a portion of a wearable audio device 400 before installation of a speaker assembly. In some examples, the wearable audio device 400 can include a housing 408, a first aperture 416 and a second aperture 418. In some examples, the securement arm can extend from a proximal end to a distal end, and the first aperture 416 can be distal to the second aperture 418. The wearable audio device 400 can also include seals 444a-b. The seal 444a can be disposed about the first aperture 416, and the seal 444b can be disposed about the second aperture 418. The seals 444a-b can be manufactured from foam, thermoplastic, composites, silicone, rubber, or other materials. The wearable audio device 400 can also include cosmetic meshes 442a-b. The cosmetic mesh 442a can be disposed over the first aperture 416, and the cosmetic mesh 442b can be disposed over the second aperture 418. The cosmetic meshes 442a-b can prevent contaminants such as dust and dirt from entering the wearable audio device. The cosmetic meshes 442a-b can also obscure the inner components of the wearable audio device from the view of a user, creating a more aesthetically pleasing product. The seals 444a-b and the cosmetic meshes 442a-b can be secured to the housing 408 via pressure sensitive adhesives, temperature sensitive adhesives, light sensitive cements, epoxy, or other methods. In some examples, the cosmetic meshes 442a-b can be secured to the housing 408, and the seals 444a-b can be secured to the cosmetic meshes 442a-b. The seals 444a-b and the cosmetic meshes 442a-b can be placed over the respective apertures 416, 418 from the inside of the housing 408 before installation of the speaker assembly shown in FIG. 4B.

FIG. 4B shows a cross-section of a portion of a wearable audio device 400 during installation of a speaker assembly 414. The speaker assembly can include a housing 434. In some examples, the speaker assembly 414 can be inserted into the housing 408 of the wearable audio device. The speaker assembly 414 can abut an angled portion of the wearable audio device 400. In some examples, the speaker assembly 414 can abut the first seal 444a, the cosmetic mesh 442a, or an angled surface of the housing 408 upon insertion of the speaker assembly 414 into the housing 408. In some examples, the speaker assembly 414 can include a notch 446 configured to receive a wedge 448. In some examples, the notch 446 can extend distally from a proximal side of the housing 434. Before the wedge 448 is inserted into the notch 446, as shown in FIG. 4B, the speaker assembly 414 can fit loosely within the housing 408. In some examples, the wedge 448 can be manufactured from metal, composites, silicone, rubber, plastics, other materials, or a combination thereof.

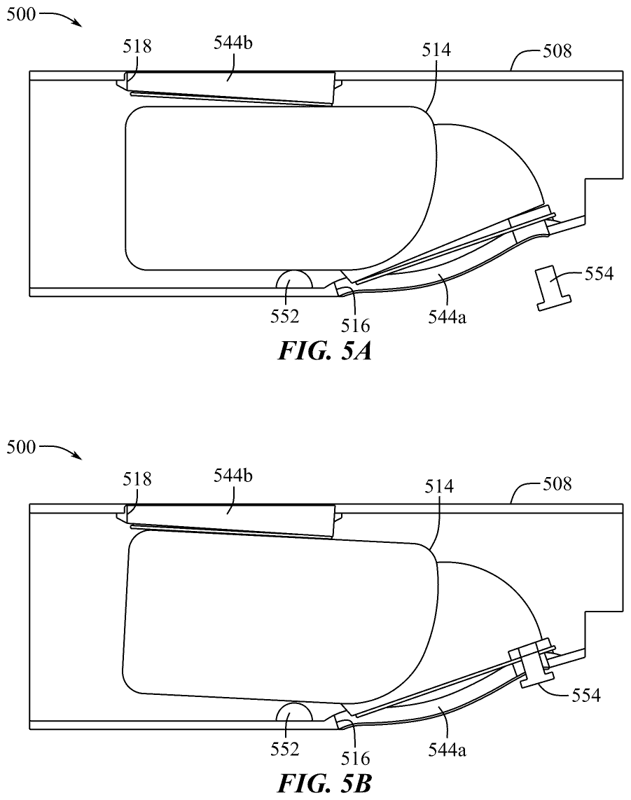

FIG. 4C shows a cross-section of a portion of a wearable audio device 400 after installation of the speaker assembly 414. As shown in FIG. 5C, the wedge 448 can have a tapered geometry extending into the notch 446. The wedge 448 can cause a force generally normal to the housing 434 of the speaker assembly 414 and generally normal to the housing 408 of the wearable audio device 400 to compress the second seal 444b between the housing 434 of the speaker assembly 414 and the housing 408 of the wearable audio device 400. The normal force caused by the wedge 448 can facilitate a tight seal between the speaker assembly 414 and the seal 444b. By facilitating a tight seal between the speaker assembly 414 and the seal 444b, the wedge can improve audio quality and durability of the wearable audio device 400. In some examples, the tight seal created by the wedge 448 can direct audio output from the speaker assembly through the second aperture 418. Directing audio output from the speaker assembly 414 through the second aperture 418 can improve the noise-cancellation function of the speaker assembly 414 as described in reference to FIG. 3. Additionally, the tight seal facilitated by the wedge 448 can prevent the speaker assembly 414 from displacing within the housing 408. In some examples, insertion of the wedge 448 into the notch 446 can also cause a force substantially parallel to the notch 446, thus pressing the speaker assembly 414 into the seal 444a, creating a tight seal.

In some examples, the wearable audio device can include hard-stop features 450a-b. The hard-stop features 450a-b can be integrally formed with the housing 408 or attached via securement methods such as screws or adhesives. The hard-stop features 450a-b can limit the deflection of the speaker assembly 414 in response to insertion of the wedge 448. The hard-stop features 450a-b can be configured to limit the speaker assembly 414 to a desired amount of deflection, thus controlling the pressure of the speaker assembly 414 against the seals 444a-b. Controlling the pressure of the speaker assembly 414 against the seals 444a-b can control audio quality, longevity of the seals 444a-b, and protect the speaker assembly 414 from being plastically deformed. In some examples, the hard-stop features 450a-b can also cause a normal force of the speaker assembly 414 against the wedge 448, increasing the frictional force between the speaker assembly 414 and the wedge 448 to prevent the wedge 448 from displacing within the housing 408. In some examples, the wedge 448 is further secured in place via adhesives, screws, clips, or other securement methods. In some examples, the wedge 448 can extend from a fluid-tight seal 452 toward the notch 446. The fluid-tight seal 452 can be disposed between the housing 434 and an electronic component, such as a battery, a projector, a processor, or another electronic component.

Any of the features, components, and/or parts, including the arrangements and configurations thereof shown in FIGS. 4A-4C can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIGS. 4A-4C. More example of speaker assemblies, wearable audio devices, and manufacturing methods are described below in reference to FIGS. 5A-5B.

FIGS. 5A-5B show another example of a cross-section of a portion of a wearable electronic device 500 during and after installation of a speaker assembly 514. In some examples shown in FIGS. 5A-5B, the speaker assembly can pivot to form a tight seal between the speaker assembly 514 and seals 544a-b disposed about apertures 516, 518 in an elongate housing 508 of the wearable electronic device 500. FIG. 5A shows a portion of a wearable electronic device 500, including an elongate housing 508 having a longitudinal axis and defining a first aperture 516 and a second aperture 518. The wearable electronic device 500 can also include a fulcrum 552 disposed within the elongate housing 508 longitudinally between the first aperture 516 and the second aperture 518. A speaker assembly 514 can be disposed within the elongate housing 508. During installation, the speaker assembly 514 can initially fit loosely within the elongate housing 508. In some examples, the wearable electronic device 500 can include first and second seals 544a-b disposed about the apertures 516, 518. In some examples, the first seal 544a can be disposed about the first aperture 516 between the speaker assembly 514 and the elongate housing 508, and the second seal 544b can be disposed about the second aperture 518 between the speaker assembly 514 and the elongate housing 508. FIG. 5A also shows a fastener 554 configured to extend through the elongate housing 508 and engage the speaker assembly 514. In some examples, the fastener 554 can be a pin, screw, clip, or other fastening device. The fastener can be retained by the elongated housing 508 by threads, adhesives, or another retaining method. In some examples, the fulcrum 552 can be disposed longitudinally between the second aperture 518 and the fastener 554. Disposition of the fulcrum longitudinally between the second aperture 518 and the fastener 554 can ensure that tightening of the fastener 554 results in rotation of the speaker assembly 514 toward the second aperture 518.

FIG. 5B shows a portion of a wearable electronic device 500 after installation of a speaker assembly 514. The wearable electronic device 500 can include a fastener 554 extending through the elongate housing 508 and engaging the speaker assembly 514 to fix the speaker assembly 514 against the fulcrum 552 within the elongate housing 508. In some examples, a tightening of the fastener 554 can be configured to rotate the speaker assembly 514 about the fulcrum 442 to draw the speaker assembly 514 against the elongate housing 508 at the first aperture 516 and draw the speaker assembly 514 against the elongate housing 508 at the second aperture 518. Drawing the speaker assembly 514 against the elongate housing 508 can cause the speaker assembly 514 to compress the first seal 544a with a first force normal to the elongate housing 508 based on the rotation of the speaker assembly 514 about the fulcrum 552. In some examples, the speaker assembly 514 can also compress the second seal 544b with a second force normal to the elongate housing 508 based on the rotation of the speaker assembly 514 about the fulcrum 552. Compressing the first seal 544a can direct audio output through the first aperture 516 and toward the ear of a user, improving audio quality and the overall experience of a user. Additionally, compressing the second seal 544b can direct audio output through the second aperture 518 and away from a user. In some examples where the audio output through the second aperture 518 is configured to provide noise-cancellation in response to the audio output through the first aperture 516, compressing the seal 544b can improve privacy of a user by obscuring the audio output through the first aperture 516 to people or audio detection or recording devices in the vicinity of a user.

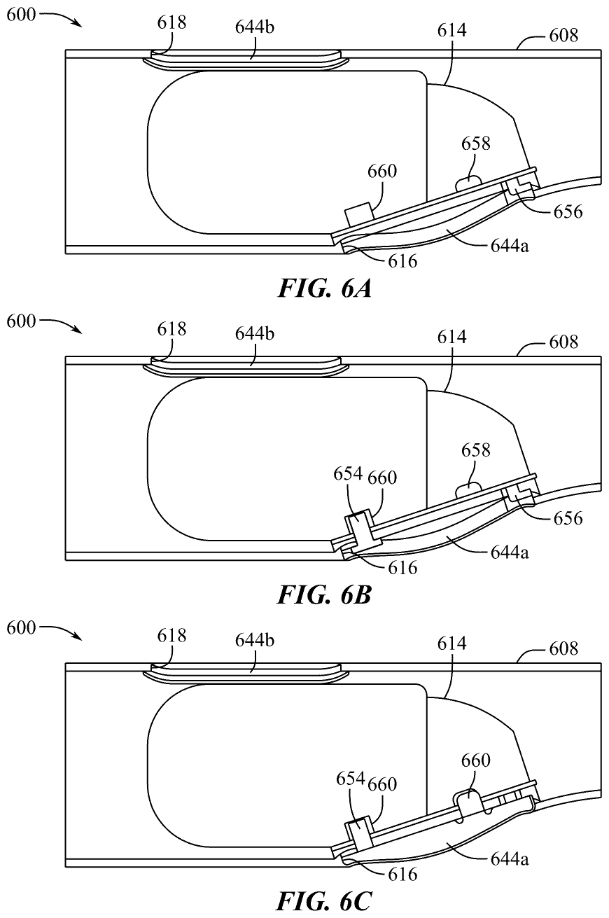

Any of the features, components, and/or parts, including the arrangements and configurations thereof shown in FIGS. 5A-5B can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIGS. 5A-5B. More examples of speaker assemblies, securement arms, and securement methods are given below in reference to FIGS. 6A-6C.

FIGS. 6A-6C show examples of wearable electronic display devices 600 during assembly. For example, FIG. 6A shows a wearable electronic device 600 including a housing 608 and a speaker assembly 614. The housing 608 can include a first aperture 616 and a second aperture 618 configured to allow sound output from the speaker assembly 614 to pass through the housing 608. In some examples, the housing 608 can include a seal 644b disposed between the speaker assembly 614 and the second aperture 618. In some examples, the speaker assembly 614 can include a foot 656 or a protrusion. The housing 608 can be configured to receive the foot 656 and prevent the speaker assembly 614 from sliding or displacing past the first aperture 616. In some examples, the speaker assembly 614 can also include a recess 658 and a cavity 660. In some examples, the cavity 660 can be configured to receive the fastener 654 shown in FIG. 6B. In some examples, the speaker assembly 614 shown in FIG. 6A can abut the seal 644b.

FIG. 6B shows the wearable electronic device 600 of FIG. 6A, with the addition of a fastener 654. In some examples, the fastener 654 can extend through the housing 608 and into the speaker assembly 614. The fastener 654 can draw the speaker assembly 614 toward the first aperture 616. The fastener 654 can also prevent the speaker assembly 614 from displacing and prevent the foot 656 from slipping out of the housing 608. In some examples, the recess 658 can also be filled with an adhesive in preparation for the installation of other components. FIG. 6C shows the wearable electronic device 600 of FIGS. 6A-6B with the addition of a seal 644a disposed over the first aperture 616. In some examples, the seal 644a can be installed from the exterior of the housing 608 and can include a protrusion 662 that can extend into the recess 658. In some examples, the protrusion 662 can be secured to the recess 658 via an adhesive. The seal 644a can also cover the fastener 654. In some examples, the seal 644a can prevent the fastener from becoming detached from the housing 608 and the speaker assembly 614. The seal 644a can also obscure the fastener 654 from the field of view of a user, creating a more aesthetically pleasing product. Additionally, the seal 644a can direct audio output from the speaker assembly 614 through the first aperture 616, improving audio quality and increasing the clarity and volume of the audio output.

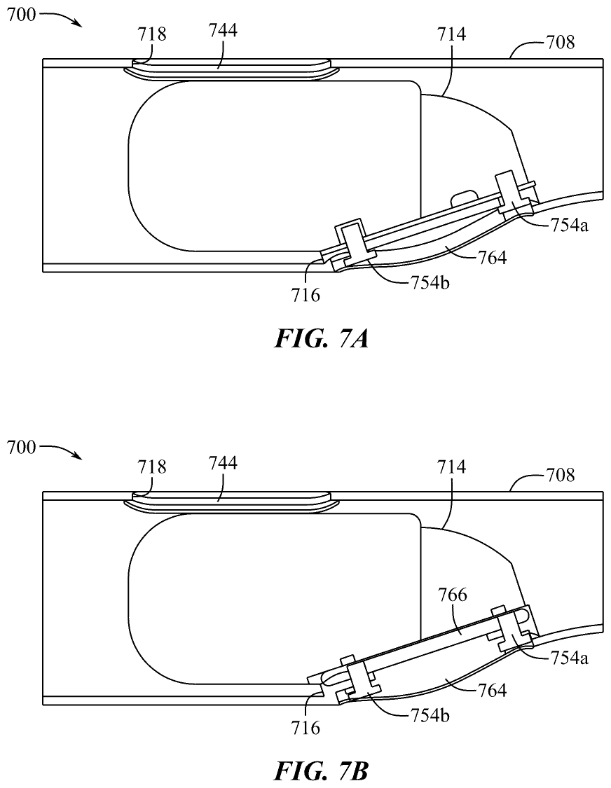

Any of the features, components, and/or parts, including the arrangements and configurations thereof shown in FIGS. 6A-6C can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIGS. 6A-6C. More examples of speaker assembly attachment methods and components are given below in reference to FIGS. 7A-7B.

FIG. 7A shows another example of a wearable electronic device 700 including a housing 708 and a speaker assembly 714. The housing 708 can include a first aperture 716 and a second aperture 718 configured to allow audio output from the speaker assembly 714 to exit the housing 708. The speaker assembly can abut a seal 744 disposed between the speaker assembly 714 and the second aperture 718. The speaker assembly 714 can also be configured to receive fasteners 754a-b the fasteners 754a-b can extend through the housing 708 and secure the speaker assembly 714 to the housing 708. The wearable electronic device 700 can also include an external seal 764 configured to attach to the outside of the housing 708 over the first aperture 716. The external seal 764 can cover the fasteners 754a-b and protect the speaker assembly 714 from damage, contaminants, or moisture. The external seal 764 can also create a seal to direct audio output from the speaker assembly 714 out the housing 708 through the first aperture. The external seal 764 can be attached to the wearable electronic device 700 via adhesives, clips, fasteners, or other methods. The external seal 764 can also be manufactured from foam, plastic, rubber, composites, or other material.

The wearable electronic device 700 shown in FIG. 7B can be substantially similar to the wearable electronic device 700 shown in FIG. 7A, except for the addition of a radial seal 766. The radial seal 766 can be disposed between the speaker assembly 714 and the first aperture 716. The fasteners 754a-b can draw the speaker assembly 714 toward the first aperture 716, compressing the radial seal 766 and creating a tight seal between the speaker assembly 714 and the first aperture 716. The tight seal created by the radial seal can improve the fluid connection between the speaker assembly 714 and the first aperture 716, improving the clarity, volume, and direction of the audio output by the speaker assembly 714.

Any of the features, components, and/or parts, including the arrangements and configurations thereof shown in FIG. 7A-7B can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 7A-7B.

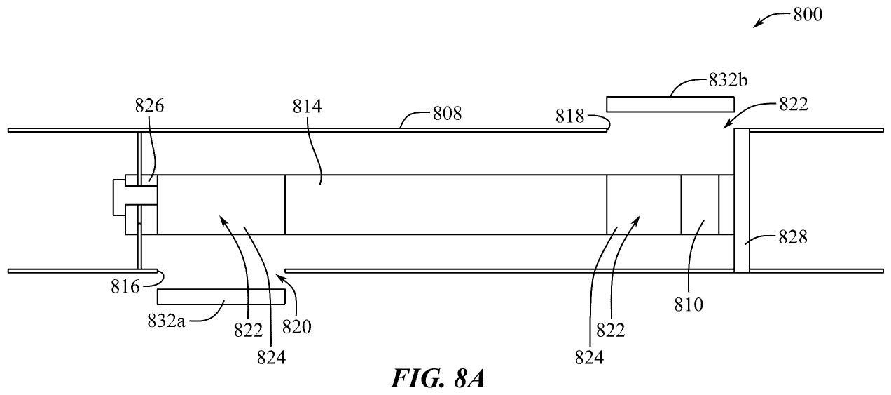

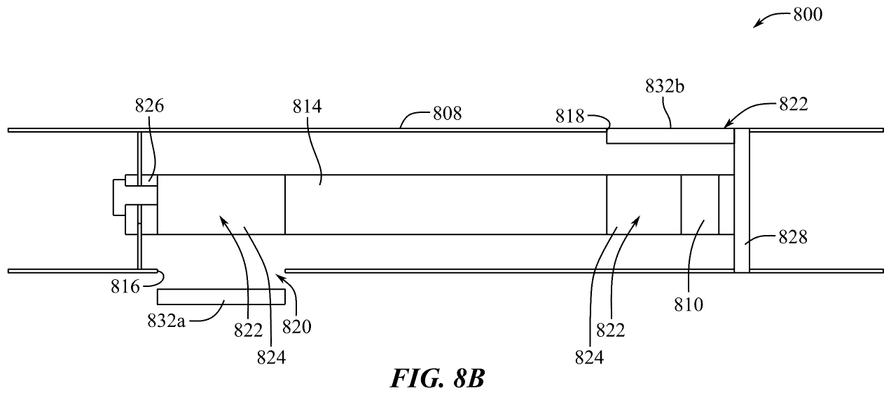

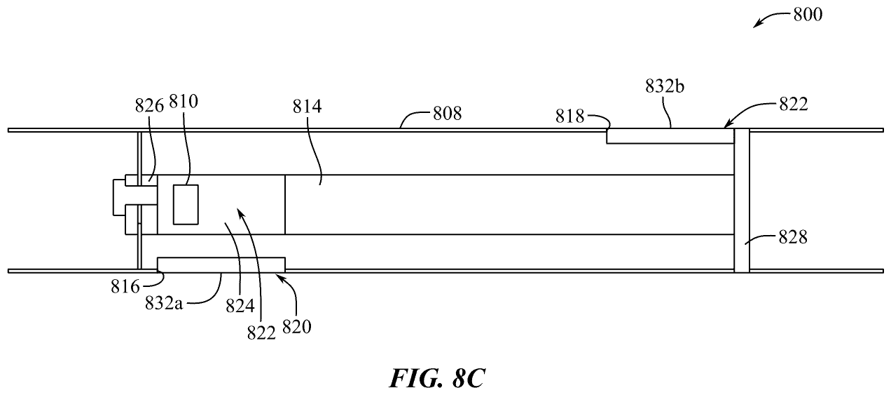

FIGS. 8A-8C show cross-sections of portions of examples of securement arms 800 for a wearable electronic device similar to 100, and speaker assemblies 814. In FIGS. 8A-8C, the securement arm 800 can define a housing 808. In some examples, the housing 808 can be hydroformed. In some examples, the housing 808 can define a tubular shape. In some examples, the housing 808 can be a curved surface. The securement arm 800 can further define a first aperture 816 and a second aperture 818. In some examples, the first aperture 816 and the second aperture 818 can be configured to allow sound to exit the arm housing 808. The securement arm 800 can also include one or more speakers within a speaker assembly 814 disposed within the housing 808 and configured to emit audio output. In some examples, the securement arm 800 can include an acoustic seal 832a disposed about the first aperture 816 between the speaker assembly 814 and the securement arm 800. Similarly, in some examples, the securement arm 800 can include an acoustic seal 832b disposed about the second aperture 818 between the speaker assembly 814 and the securement arm 800.

In some examples, the one or more acoustic seals 832a-b can enhance the audio output quality by forming a seal between the speaker assembly 814 and the securement arm 800. In some examples the seal formed by acoustic seals 832a-b can be tight seals. By creating one or more tight seals between the speaker assembly 814 and the securement arm 800, the acoustic seals 832a-b can prevent vibrations of the speaker assembly 814 against the housing 808. In some examples, the acoustic seals 832a-b can improve audio quality by directing audio output out the first aperture 816 and/or the second aperture 818. Directing audio output out the apertures 816, 818 can prevent sound waves from resonating within the housing 808, reducing sound quality. In some examples, the acoustic seals 832a-b can be a fluid-tight seal. The acoustic seals 832a-b being fluid-tight seals can prevent moisture from entering the securement arm 800, thus improving durability and longevity of the securement arm 800 by protecting the internal components from contaminants such as water, sweat, condensation, dust, dirt, and other contaminants.

The securement arm 800 for a wearable electronic device is shown in FIGS. 8B and 8C can be substantially similar to the wearable electronic device 800 shown in FIG. 8A, except the acoustic seals 832a-b are both shown displaced in FIG. 8A, showing the apertures 816, 818 and audio ports 820, 822 more clearly. Acoustic seal 832b is shown disposed in the second audio port 822 where the acoustic seal 832a is shown displaced. In some examples, such as is shown in FIG. 8A, a direct seal can be included in one port, such as acoustic seal 832b. In some examples, the speaker or other components included in the housing 808, such as the speaker assembly 814, electronic components 810, and so forth, can be assembled within the housing 808 through both or either acoustic seal 832a-b. In some examples, such as is shown in FIG. 8A, components of the securement arm 800, such as speaker assembly 814, can be pre-assembled and slid into the housing 808 through one or both ports, 832a-b. In some examples, one or all of the seals, such as 826, 828 can be direct seals, such as an endcap seal, and can already be disposed within the housing 808 during assembly. Direct seals can include face seals or endcap seals and can seal a surface such as the apertures 816, 818 or can seal and separate the interior of the housing 808 to create separate interior cavities within the housing 808, often with static applications, to prevent egress.

In some examples, one or all of the seals, such as 826, 828 can be indirect seals, such as radial seals. Indirect seals such as radial seals can include mechanical seal that prevents egress by applying compression to an outside surface and to an inside surface. Indirect seals in some examples can also be placed during or after assembly of the speaker assembly 814 and other components of the securement arm 800. FIG. 8C shows a fully assembled and sealed wearable securement arm 800 with acoustic seal 832a-b both in place. The acoustic seals 832a-b can be manufactured from foam, thermoplastic, composites, silicone, rubber, or other materials. The seals 326, 328 can be manufactured from the same material or a different material and can be manufactured from foam, thermoplastic, composites, silicone, rubber, or other materials. The seals of 826, 828 can further include the features described in FIGS. 4A-7B.

In some examples, the speaker assembly 814 can be configured to emit audio output. The speaker assembly 814 can be configured to emit one audio output through the first aperture 816 and emit a different audio output through the second aperture 818. In some examples, the audio output emitted through the first aperture 816 can be directed toward the ear of a user, and can be audio from music, videos, notifications, or other functions performed by the wearable electronic display device 100 described in reference to FIG. 1. The audio emitted through the second aperture 818 can be noise-cancelling audio directed away from the ear of a user and can be configured to destructively interfere with the audio emitted through the first aperture 816, thus decreasing the amount of volume of audio emitted through the first aperture 816 audible to people or audio detection devices in the vicinity of the user. By decreasing the amount of audio output detectable by people or devices in the vicinity of the user, the privacy of the user can be protected.

In some examples, the speaker assembly 814 can include a first audio port 820 and a second audio port 822. In some examples, the first audio port 820 can be in fluid communication with a front speaker volume and the second audio port 822 can be in fluid communication with a rear speaker volume. In some examples, the first port 820 can be aligned with the first aperture 816 and the second port 822 can be aligned with the second aperture 818. In some examples, the first acoustic seal 832a can be disposed in the first aperture 816 and the first port 820 within the housing 808 and a second seal 832b can be disposed about the second aperture 818 and the second port 822 within the housing 808. In some examples, the first audio port 820 can be aligned with the first aperture 816 and the second audio port 822 can be aligned with the second aperture 818.

In some examples, the first aperture 816 and the second aperture 818 can each include an acoustic mesh 824. The acoustic mesh 824 can improve the quality of the audio released from the audio ports 820, 822 and can protect the internal components of the securement arm 800 from contamination, damage, or other external factors. The meshes 824 can also obscure the inner components of the wearable audio device from the view of a user, creating a more aesthetically pleasing product. Additionally, the speaker assembly 814 can include a first seal 826 and a second seal 828. The seals 826, 828 can abut the inner surfaces of the housing 808 and can provide frictional force to prevent the speaker assembly 814 from displacing. In some examples, the seals 826, 828 can also be fluid-tight seals. The seals 832a-b and the meshes 842 can be secured to the housing 808 via pressure sensitive adhesives, temperature sensitive adhesives, light sensitive cements, epoxy, or other methods.

In some examples, the securement arm 800 may include one or more acoustic openings within the audio ports 820, 822. The acoustic openings can define the front speaker volume in fluid communication with the first audio port 820, and the rear volume in fluid communication with the second audio port 822. The acoustic openings can include one or more acoustic meshes 824. In some examples, such as that shown in FIGS. 8B-8C, only one acoustic opening is defined to minimize space required by the speaker assembly 814. However, in other examples, such as FIG. 8A, the securement arm 800 may have multiple acoustic openings. Additionally, the examples shown in FIGS. 8A-8C are not meant to limit the positioning of the acoustic openings, as the acoustic openings can be positioned anywhere throughout the housing 808, including but not limited to the locations shown in FIGS. 8A-8C.

In some examples, one or more electronic components 810 can be disposed in the housing 808 of the securement arm 800. In some examples the electronic component 810 can be disposed within the acoustic opening. In some examples, the electronic component 810 can be disposed within the acoustic mesh 824. In some examples, the electronic component 810 can be aligned with the speaker assembly 814. In some examples, such as that shown in FIG. 8A, the electronic component 810 can be disposed between the second seal 828 and the speaker assembly 814, allowing both the rear end of the speaker assembly 814 and the electronic component 810, such as a microphone, to utilize the second audio port 822. In other examples, such as that shown in FIG. 8C, the electronic component 810 can be disposed between the first seal 826 and the speaker assembly 814, allowing the front end of the speaker assembly 814 and the electronic component 810 to both utilize the first audio port 820. In some examples not shown in FIGS. 8A-8C, the electronic component can be positioned proximal to the first seal 826 or the electronic component can be positioned distal to the second seal 828. These examples are illustrative of the numerous positions within the housing that the electronic component 810 can be placed and is not intended to be exhaustive. One or more electronic components 810 can be placed throughout the housing depending on the electronic components' 810 needs and the interference of some electronic components 810 with other electronic components 810 or with the speaker assembly 814.

Any of the features, components, and/or parts, including the arrangements and configurations thereof shown in FIGS. 8A-8C can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 8A-8C.

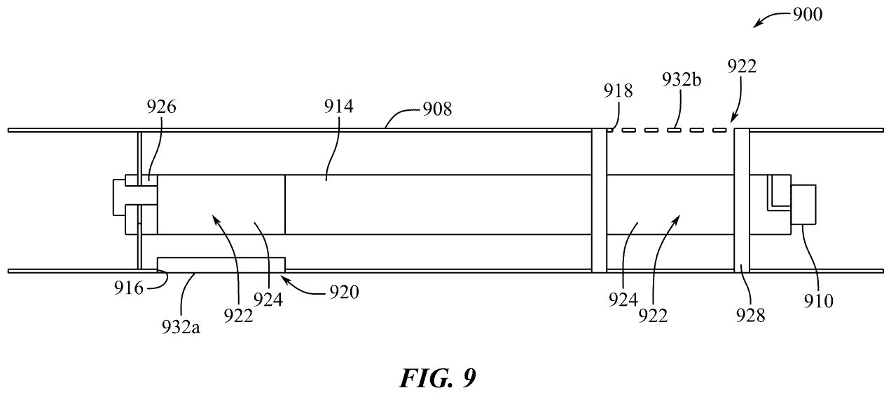

FIG. 9 shows a cross-section of a portion of an example of a securement arm 900 and speaker assembly 914. The securement arm 900 can be substantially similar to, including some or all of the features of the securement arms described herein, such as securement arms 200, 300, 400, 500, 600, 700 and 800. The securement arm 900 can define a housing 908. The securement arm 900 can define a first aperture 916 and a second aperture 918. In some examples, the first aperture 916 and the second aperture 918 can be configured to allow sound to exit the arm housing 908. The securement arm 900 can also include one or more speakers within a speaker assembly 914 disposed within the housing 908 and configured to emit audio output. In some examples, the securement arm 900 can include an acoustic seal 932a disposed about the first aperture 916 between the speaker assembly 914 and the securement arm 900. Similarly, in some examples, the securement arm 900 can include an acoustic seal disposed about the second aperture 918 between the speaker assembly 914 and the securement arm 900. The one or more acoustic seals can enhance the audio output quality by forming a seal between the speaker assembly 914 and the securement arm 900.

The securement arm 900 can include one or more seals 926, 928, 930. In some examples, a first seal 926 can be disposed within the housing 908 proximal to the speaker assembly 914 and the first audio port 920. In some examples, a second seal 928 can be disposed within the housing 908 distal to the speaker assembly 914 and the second audio port 922. In some examples, a third seal 930 can be disposed within the housing between the speaker assembly 914 and the second seal 928. The seals 926, 928, 930 can prevent dust, water, sweat, or other contaminants from entering the housing 908 and damaging the electronic components 910 and/or speaker assembly 914 disposed therein. In some examples, one or more of the seals 926, 928, 930 can be fluid tight. Although electric component 910 is shown on distal to the second seal 928, electronic components 910 are not limited to just one electric component, and the electric components 910 can also be positioned proximal to the first seal 926, between the first seal 926 and the third seal 930, and/or between the third seal 930 and the second seal 928. In some examples, the third seal 930 can seal the first audio port 920 from the second audio port 922, enclosing each port 920, 922 and preventing fluid communication between the ports 920, 922 or between the front end and the rear end of speaker assembly 914 and/or electronic component 910.

The seals 926, 928, 930 can be manufactured from foam, thermoplastics, composites, silicone, rubber, or other materials. The seals 926, 928, 930 can include features such as a foot or a protrusion to prevent the seals 926, 928, 930 or the speaker assembly 914 from sliding or displacing past the first aperture 916 or the second aperture 918. The seals 926, 928, 930 can include any combination of direct and indirect seals. For example, the seals 926, 928, 930 can include direct seals include face seals or endcap seals. A face seal can seal a surface, often with static applications, to prevent egress. For example, a face seal can include any seal precisely machined to the size of the housing 908 to press against the housing 908 and prevent egress through the seal. Indirect seals can include for example radial seals. A radial seal is a mechanical seal that prevents egress by applying compression to an outside surface and to an inside surface. The seals 926, 928, 930 can include apertures, vents, or other similar components designed to allow egress through the seals 926, 928, 930.

In some examples, the securement arm 900 may include one or more acoustic openings aligned with the audio ports 920, 922. The acoustic openings can define the front speaker volume in fluid communication with the first audio port 920, or the rear volume in fluid communication with the second audio port 922. The acoustic opening(s) can include one or more acoustic meshes 924. The acoustic or cosmetic meshes 924 can improve the aesthetic qualities of the securement arm 900 and can further protect the internal components of the securement arm 900 from contamination, damage, or other external factors. The acoustic opening at the second audio port 922 shown in FIG. 9 can allow egress between two electronic components such as speaker assembly 914 and electronic component 910 while still separating the speaker assembly 914 and electronic component 910 through the use of the second seal 928 and third seal 930. In the example shown in FIG. 9, the first seal 926 is shown as a direct seal, the second seal 928 is shown as the first indirect seal, and the third seal 930 is shown as the second indirect seal. A tight seal created by a radial seal can improve the fluid connection between components such as the speaker assembly 914, the first aperture 916, and/or the electronic component 910 (for example a microphone), improving the clarity, volume, and direction of the audio output by the speaker assembly 914 and/or the electronic component 910. This configuration of indirect and direct seals that is shown in FIG. 9 is not intended to be limiting, as all of the seals 926, 928, 930 are contemplated to include any combination of direct and indirect seals.

In some examples, the housing 908 may include an acoustic seal and/or a micro perforation 932b disposed in the apertures 916, 918. Although FIG. 9 shows an acoustic seal 932a disposed in the first aperture 916 and a micro perforation 932b disposed in the second aperture 918, this is included simply as an example and is not meant to be limiting. All acoustic seals 932a may be disposed in all the one or more apertures 916, 918, all micro perforations 932b can be disposed in the apertures 916, 918, or any combination of acoustic seals 932a and micro perforations 932b can be disposed in the apertures 916, 918.

Any of the features, components, and/or parts, including the arrangements and configurations thereof shown in FIG. 9 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 9.

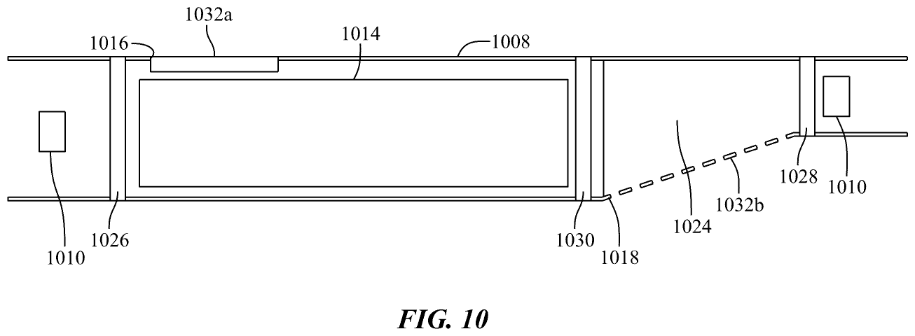

FIG. 10 shows a cross-section of a portion of an example of a securement arm 1000 and speaker assembly 1014. The securement arm 1000 can be substantially similar to, including some or all of the features of the securement arms described herein, such as securement arms 200, 300, 400, 500, 600, 700, 800, and 900. The components of FIG. 10, such as the electronic component(s) 1010, meshes 1024, and seals 1026, 1028, 1030 can be substantially similar, including some or all of the features of the electronic component(s) 910, meshes 924, and seals 926, 928, 930 respectfully of securement arm 900. The speaker assembly 1014 can be inserted into the housing 1008 of the wearable audio device. In some examples, the housing 1008 can define a tapered geometry, an example of the tapered geometry is shown in FIG. 10. FIG. 10 shows one of many possible tapered geometries of housing 1008. The speaker assembly 1014 can abut an angled portion of the wearable audio device, such as 100. In some examples, the speaker assembly 1014 can abut the third seal 1030, a cosmetic mesh 1022, or an angled surface of the housing 1008 upon insertion of the speaker assembly 1014 into the housing 1008. The tapered geometry can improve audio quality and durability of the wearable audio device 100. Although the speaker assembly 1014 is shown as rectangular in FIG. 10, the speaker assembly can also be shaped similarly to the tapered geometry or wedge of the housing 1008 or it can have a unique geometry. In some examples, such as that shown in FIG. 10, the speaker assembly 1014 can fit loosely within the housing 1008. In some examples, such as that shown in FIG. 10, the speaker assembly 1014 can fit snugly against the housing 1008. The tapered geometry or wedge of securement arm 1000 and the components thereof can be substantially similar to, including some or all of the features of the similar securement arms described herein, such as securement arms 400, 500, 600, and 700. The housing 1008 can be manufactured from metal, composites, silicone, rubber, plastics, or other materials, or a combination thereof.

The example shown in FIG. 10 shows the first aperture 1016 at the top of the securement arm 1000 rather than at the bottom of the securement arm 1000, as is shown in FIGS. 8A-9. However, these configurations are not meant to be limiting, and it is contemplated that one or more apertures 1016, 1018 can be included in the housing 1008 at any location. For example, the apertures 1016, 1018 may be located proximally or distally to the speaker assembly. In another example, the apertures 1016, 1018 can be located at the top and bottom of the securement arm 1000 as shown in FIG. 10, or both apertures 1016, 1018 may be located at the top or the bottom, or within the inside or outside of the securement arm 1000. In some examples, the housing 1008 may include an acoustic seal 1032a and/or a micro perforation 1032b disposed in the apertures 1016, 1018. Similarly to FIG. 9, FIG. 10 shows an acoustic seal 1032a disposed in the first aperture 1016 and a micro perforation 1032b disposed in the second aperture 1018. This example including both an acoustic seal 1032a and a micro perforation 1032b is included simply as an example and is not meant to be limiting.

Any of the features, components, and/or parts, including the arrangements and configurations thereof shown in FIG. 10 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 10.

To the extent applicable to the present technology, gathering and use of data available from various sources can be used to improve the delivery to users of invitational content or any other content that may be of interest to them. The present disclosure contemplates that in some instances, this gathered data may include personal information data that uniquely identifies or can be used to contact or locate a specific person. Such personal information data can include demographic data, location-based data, telephone numbers, email addresses, X® (formerly TWITTER®) ID's, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to deliver targeted content that is of greater interest to the user. Accordingly, use of such personal information data enables users to calculated control of the delivered content. Further, other uses for personal information data that benefit the user are also contemplated by the present disclosure. For instance, health and fitness data may be used to provide insights into a user's general wellness or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the U S, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of advertisement delivery services, the present technology can be configured to allow users to select to “opt in” or “opt out” of participation in the collection of personal information data during registration for services or anytime thereafter. In another example, users can select not to provide mood-associated data for targeted content delivery services. In yet another example, users can select to limit the length of time mood-associated data is maintained or entirely prohibit the development of a baseline mood profile. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences based on non-personal information data or a bare minimum amount of personal information, such as the content being requested by the device associated with a user, other non-personal information available to the content delivery services, or publicly available information.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art that many modifications and variations are possible in view of the above teachings.

What is claimed is:

1. A wearable electronic display device, comprising:
a display frame;
a securement arm extending distally from the display frame, the securement arm comprising a housing defining a first aperture and a second aperture;
a speaker assembly disposed within the housing, the speaker assembly comprising:
a first audio port aligned proximal relative to the first aperture and in fluid communication with a first terminal end of the speaker assembly; and
a second audio port aligned proximal relative to the second aperture and in fluid communication with a second terminal end of the speaker assembly;
a first seal disposed within the housing proximal to the speaker assembly and the first audio port;
a second seal disposed within the housing distal to the speaker assembly and the second audio port; and
a third seal disposed within the housing between the speaker assembly and the second seal.

2. The wearable electronic device of claim 1, wherein the first seal is fluid tight.

3. The wearable electronic display device of claim 2, further comprising at least one of an acoustic seal or a micro perforation disposed about at least one of the first aperture or the second aperture between the speaker assembly and the securement arm.

4. The wearable electronic display device of claim 1, further comprising a first electronic component disposed within the housing and positioned proximal relative to the first seal or distal relative to the second seal.

5. The wearable electronic device of claim 4, wherein the first electronic component comprises a microphone.

6. The wearable electronic device of claim 5, wherein the second audio port is configured to allow fluid egress from the microphone and from at least one of the first terminal end of the speaker assembly or the second terminal end of the speaker assembly.

7. The wearable electronic display device of claim 4, further comprising a second electronic component disposed within the housing and proximal relative to the first seal or distal relative to the second seal.

8. The wearable electronic device of claim 6, wherein at least one of the first electronic component or the second electronic component include at least one or more of a microphone, a battery, a projector, a processor, a camera, or a sensor.

9. The wearable electronic device of claim 1, further comprising an acoustic opening defined by the housing between the second seal and the third seal.

10. A wearable audio device, comprising:
a securement arm including a housing, having a tapered portion defining an interior cavity, the tapered portion defining a first aperture and a second aperture; and
the housing further defining a first port proximal to the first aperture and a second port proximal to the second aperture;
wherein the tapered portion comprises:
a speaker assembly positioned between the first port and the second port;
a first seal positioned proximally from the first port;
a second seal positioned distally from the second port; and
a third seal positioned between the speaker assembly and the second port.

11. The wearable audio device of claim 10, further comprising an acoustic mesh disposed in the tapered portion.

12. The wearable audio device of claim 10, further comprising:
an electronic component disposed in the securement arm; and
a fluid-tight seal disposed between the housing and the electronic component;
wherein a wedge extends from the fluid-tight seal toward the housing into a notch.

13. The wearable audio device of claim 10, wherein the first port comprises a hinge port.

14. The wearable audio device of claim 10, further comprising an acoustic opening disposed in the housing between the second seal and the third seal and aligned proximal to the second port.

15. The wearable audio device of claim 10, wherein the first seal comprises a direct seal, the second seal comprises a first indirect seal, and the third seal comprises a second indirect seal.

16. The securement arm of claim 15, wherein a tightening of a fastener is configured to rotate the speaker assembly about a fulcrum to draw the speaker assembly against the housing at the first aperture and draw the speaker assembly against the housing at the second aperture.

17. A securement arm for a wearable electronic device, comprising:
an elongated housing defining a first aperture and a second aperture;
a speaker assembly comprising:
a first audio port aligned with the first aperture; and
a second audio port aligned with the second aperture;
a face seal disposed within the housing and aligned with a first end of the speaker assembly;
a first radial seal disposed within the housing and aligned with a second end of the speaker assembly; and
a second radial seal, the second audio port disposed between the second radial seal and the first radial seal.

18. The securement arm for a wearable electronic device of claim 17, wherein the face seal comprises a fluid tight seal.

19. The securement arm for a wearable electronic device of claim 17, wherein the second radial seal is configured to prevent fluid communication between the first audio port and the second audio port.

20. The securement arm for a wearable electronic device of claim 17, further comprising an electronic component disposed within the elongated housing distal relative to the second radial seal.
